(19) United States
(12) Patent Application Publication
(10) Pub. No.: US 2026/0189833 A1
(43) Pub. Date: Jul. 2, 2026

(54) Speaker

(71) Applicant: AAC Microtech (Changzhou) Co., Ltd., Changzhou City (CN)

(72) Inventors: Zhizhu Chen, Changzhou (CN); Zhaoyu Yin, Changzhou (CN)

(21) Appl. No.: 19/336,472

(22) Filed: Sep. 22, 2025

Related U.S. Application Data
(63) Continuation of application No. PCT/CN2024/143853, filed on Dec. 30, 2024.

(51) Int. Cl. H04R 1/06; H04R 7/12; H04R 9/02; H04R 9/06

(52) U.S. Cl. CPC H04R 1/06; H04R 9/025; H04R 9/06; H04R 7/127; H04R 2400/11

(57) ABSTRACT

The present application provides a speaker including a frame, a vibration system, and a magnetic circuit system. The vibration system includes a diaphragm, a voice coil, and a first flexible support connecting the voice coil and an external circuit. The first flexible support is arranged on one side of the voice coil and includes a first main body portion, a first extension portion, and a first lead connecting portion. Lead wires of the voice coil are electrically connected to the first lead connecting portion. The speaker of the present application can effectively reduce the possibility of lead wire breakage caused by frequent high-frequency signals.

### TECHNICAL FIELD

The present application relates to the field of acoustic-electric technology, particularly to a speaker.

### BACKGROUND

With the development of science and technology, portable electronic products, such as mobile phones, handheld game consoles, navigation devices, or handheld multimedia entertainment devices, are widely used in people's daily lives. In these mobile electronic devices, voice playback devices are essential components, and the quality of voice directly affects the user experience when using these mobile electronic devices. Therefore, the requirements for speakers used in these devices are becoming increasingly higher.

A speaker includes a frame, a vibration system fixed to the frame, and a magnetic circuit system driving the vibration system to vibrate. To fully utilize the magnetic field generated by the magnetic circuit system, the related technology's vibration system includes at least two parallel voice coils, which are connected through bent FPC to conduct current. However, after bending, the FPC is positioned away from the voice coil, and the dome's high-frequency resonance mode has large amplitude, which easily leads to lead wire fatigue and breakage.

Therefore, it is necessary to provide a product that solves the above problems.

### SUMMARY

The object of the present application is to provide a speaker that can effectively reduce the possibility of lead wire breakage caused by frequent high-frequency signals.

To achieve the above purposes, the present invention provides a speaker, comprising a frame, a vibration system fixed to the frame, and a magnetic circuit system driving the vibration system to vibrate. The vibration system includes a diaphragm fixed to the frame, a voice coil driving the diaphragm to vibrate and generate sound, and a first flexible support connecting the voice coil and an external circuit. The voice coil includes a first voice coil and a second voice coil that are arranged side by side along a first direction and fixed to a side of the diaphragm close to the magnetic circuit system.

The first flexible support is arranged on one side of the voice coil along a second direction perpendicular to the first direction and includes a first main body portion fixed to the frame, a first extension portion extending and bending from the first main body portion toward the diaphragm and fixed to the diaphragm, and a first lead connecting portion extending from the first extension portion toward a middle position between the first voice coil and the second voice coil. The first direction and the second direction are both perpendicular to a vibration direction of the diaphragm, and lead wires of the voice coil are electrically connected to the first lead connecting portion.

In addition, the first main body portion is provided with an external solder pad connected to the external circuit, the lead wires include a first input lead wire and a second output lead wire, and the first lead connecting portion includes a first solder pad electrically connected to the first input lead wire and a second solder pad electrically connected to the output lead wire.

In addition, the first main body portion includes two elastic arms spaced apart along the first direction, and the first extension portion includes two supporting parts extending and bending from the two elastic arms respectively toward the diaphragm and fixed to the diaphragm, and a conductive part connecting the two supporting parts.

In addition, the speaker further includes a second flexible support arranged on another side of the voice coil along the second direction, the second flexible support includes a second main body portion fixed to the frame, a second extension portion extending and bending from the second main body portion toward the diaphragm and fixed to the diaphragm, and a second lead connecting portion extending from the second extension portion toward the middle position between the first voice coil and the second voice coil; the lead wires include a first output lead wire and a second input lead wire, and the second lead connecting portion includes a third solder pad electrically connected to the first output lead wire and a fourth solder pad electrically connected to the second input lead wire.

In addition, the magnetic circuit system includes a lower plate, two inner magnetic circuit portions connected to the lower plate, and an outer magnetic circuit portion arranged surrounding the two inner magnetic circuit portions; the two inner magnetic circuit portions correspond to the voice coil and are respectively surrounded by the first voice coil and the second voice coil, and the two inner magnetic circuit portions and the outer magnetic circuit portion jointly form a magnetic gap in which the voice coil is inserted.

In addition, each of the two inner magnetic circuit portions includes an inner magnet fixed to the lower plate and an inner pole piece covering a side of the inner magnet away from the lower plate, and the outer magnetic circuit portion includes an outer magnet fixed to the lower plate and an outer pole piece covering a side of the outer magnet away from the lower plate.

In addition, the outer pole piece includes two first axial sides extending along the first direction and two first protruding parts extending from the two first axial sides respectively away from the voice coil.

In addition, the outer magnet includes a first outer magnetic part arranged between the two inner magnets, four second outer magnetic parts surrounding the two inner magnets; each of the four second outer magnetic parts includes a first side extending along the first direction and a second side extending along the second direction, and the outer magnet further includes a third outer magnetic part arranged between adjacent two first sides.

In addition, a length d1 of the first side in the second direction is smaller than a length d2 of the third outer magnetic part in the second direction.

In addition, a length d3 of the first outer magnetic part in the second direction is smaller than a length d4 of the inner magnet in the second direction.

According to the above-mentioned speaker, the vibration system includes a diaphragm fixed to the frame, a voice coil driving the diaphragm to vibrate and generate sound, and a first flexible support connecting the voice coil and an external circuit. The voice coil includes a first voice coil and a second voice coil that are arranged side by side along a first direction and fixed to a side of the diaphragm close to the magnetic circuit system. The first flexible support is arranged on one side of the voice coil along a second direction perpendicular to the first direction and includes a first main body portion fixed to the frame, a first extension portion extending and bending from the first main body portion toward the diaphragm and fixed to the diaphragm, and a first lead connecting portion extending from the first extension portion toward a middle position between the first voice coil and the second voice coil. The first direction and the second direction are both perpendicular to a vibration direction of the diaphragm, and lead wires of the voice coil are electrically connected to the first lead connecting portion. By arranging multiple voice coils, the structural strength of the diaphragm can be significantly improved, and the frequency of high-frequency resonance modes can be greatly increased. Meanwhile, by positioning the first lead connecting portion near the middle position between the first voice coil and the second voice coil, where the diaphragm deformation is minimal, the relative displacement between the first lead connecting portion and the voice coil can be effectively reduced, thereby reducing the possibility of fatigue breakage.

### BRIEF DESCRIPTION OF THE DRAWINGS

In order to more clearly explain the technical solutions in the embodiments of the present application, the following will briefly introduce the drawings required in the embodiments or exemplary technical descriptions. Obviously, the drawings in the following description are only for the application. In some embodiments, for those of ordinary skill in the art, without paying any creative labor, other drawings may be obtained based on these drawings, in which:

FIG. 1 is an isometric view of a speaker in accordance with an embodiment of the present application;

FIG. 2 is an exploded view of the speaker in FIG. 1;

FIG. 3 is an isometric view showing an assembly of a first flexible support, a second flexible support, and a voice coil of the speaker in FIG. 1;

FIG. 4 is an isometric view showing an assembly of an inner magnet and an outer magnet of the speaker;

FIG. 5 is a cross-sectional view of the speaker, taken along line A-A in FIG. 1.

### DETAILED DESCRIPTION OF THE EMBODIMENTS

The following will be taken in conjunction with the accompanying drawings of embodiments of the present invention, The technical scheme in the embodiments of the invention is clearly and completely described, Obviously, the described embodiments are merely part of the embodiments of the present invention, and not all embodiments are based on the embodiments of the present invention, and all other embodiments attained by those of ordinary skill in the art without inventive effort are within the scope of the present invention.

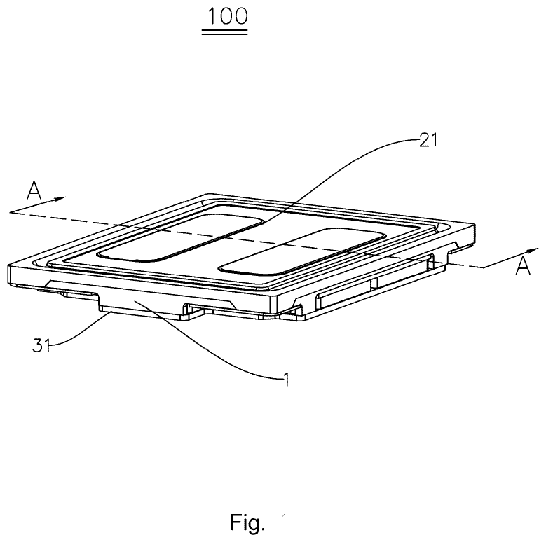

As shown in FIGS. 1-5, the present application provides a speaker 100, including a frame 1, a vibration system 2 fixed to the frame 1, and a magnetic circuit system 3 driving the vibration system 2 to vibrate. The vibration system 2 includes a diaphragm 21 fixed to the frame 1, a voice coil 22 driving the diaphragm 21 to vibrate and generate sound, and a first flexible support 23 connecting the voice coil 22 and an external circuit.

The voice coil 22 includes a first voice coil 221 and a second voice coil 222 arranged side by side along a first direction and fixed below the diaphragm 21; the first flexible support 23 is arranged on one side of the voice coil 22 along a second direction perpendicular to the first direction and includes a first main body portion 231 fixed to the frame 1, a first extension portion 232 extending and bending from the first main body portion 231 toward the diaphragm 21 and fixed to the diaphragm 21, and a first lead connecting portion 233 extending from the first extension portion 232 toward a middle position between the first voice coil 221 and the second voice coil 222, and lead wires 223 of the voice coil are electrically connected to the first lead connecting portion 233.

By arranging multiple voice coils, the structural strength of the diaphragm can be significantly improved, and the frequency of high-frequency resonance modes can be greatly increased. Meanwhile, by positioning the first lead connecting portion near the middle position between the first voice coil and the second voice coil, where the diaphragm deformation is minimal, the relative displacement between the first lead connecting portion and the voice coil can be effectively reduced, thereby reducing the possibility of fatigue breakage.

It should be noted that in this embodiment, both the first direction and the second direction are perpendicular to the vibration direction of the diaphragm.

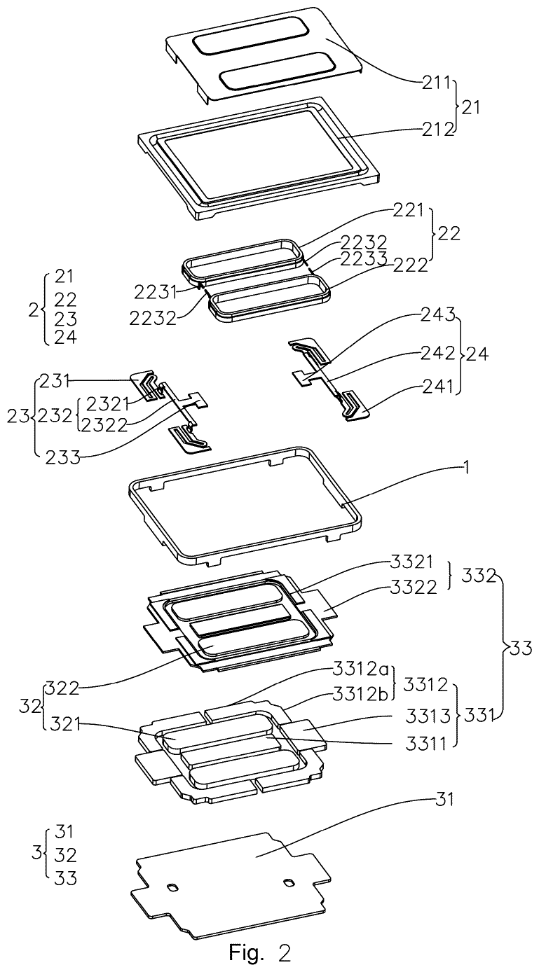

Preferably, as shown in FIG. 2, the diaphragm 21 includes a dome 211 and a suspension 212 arranged surrounding the dome 211, with both the first voice coil 221 and the second voice coil 222 fixed to the dome 211.

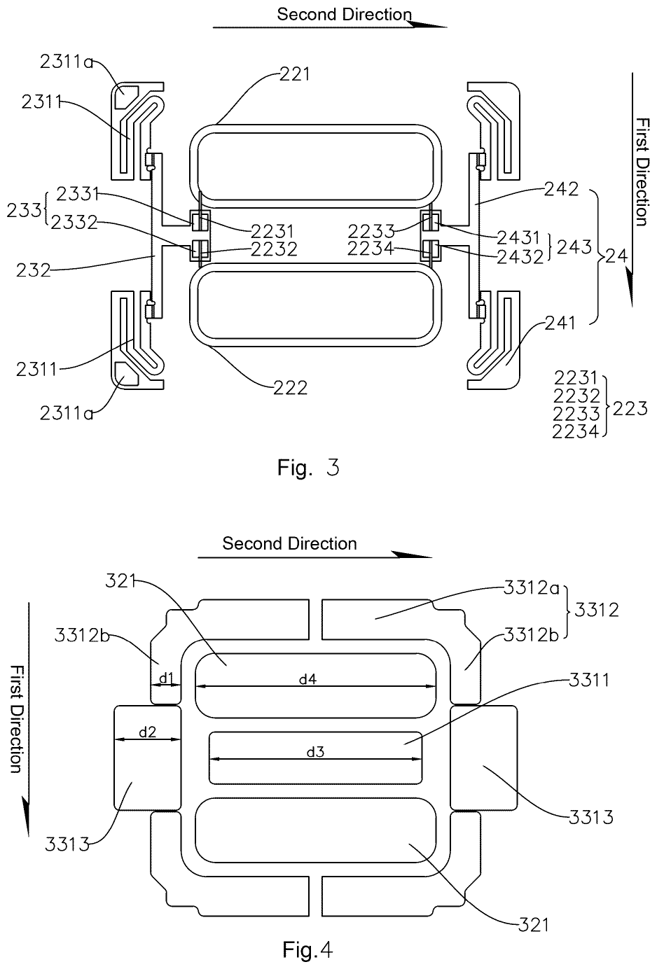

Preferably, as shown in FIG. 3, the first main body portion 231 is provided with an external solder pad 2311a connected to the external circuit, the lead wires 223 include a first input lead wire 2231 and a second output lead wire 2232, and the first lead connecting portion 233 includes a first solder pad 2331 electrically connected to the first input lead wire 2231 and a second solder pad 2332 electrically connected to the second output lead wire 2232.

As shown in FIGS. 2-3, the first main body portion 231 includes two elastic arms 2311 spaced apart along the first direction, and the first extension portion 232 includes two supporting parts 2321 extending and bending from the two elastic arms 2311 respectively toward the diaphragm 21 and fixed to the diaphragm 21, and a conductive part 2322 connecting the two supporting parts 2321. This arrangement can effectively utilize the internal space of the speaker and create favorable conditions for the arrangement of the magnetic circuit system to obtain a larger BL value.

Furthermore, the speaker also includes a second flexible support 24 arranged on another side of the voice coil 22 along the second direction. The second flexible support 24 includes a second main body portion 241 fixed to the frame 1, a second extension portion 242 extending and bending from the second main body portion 241 toward the diaphragm 21 and fixed to the diaphragm 21, and a second lead connecting portion 243 extending from the second extension portion 242 toward the middle position between the first voice coil 221 and the second voice coil 222. The lead wires 223 include a first output lead wire 2233 and a second input lead wire 2234, and the second lead connecting portion 243 includes a third solder pad 2431 electrically connected to the first output lead wire 2233 and a fourth solder pad 2432 electrically connected to the second input lead wire 2234. By extending the second lead connecting portion 243 to the middle position between the first voice coil 221 and the second voice coil 222, where the diaphragm deformation is minimal, this arrangement can shorten the lead wire length and improve the connection stability between the lead wires and solder pads, reducing the risk of voice coil lead wire fatigue breakage, while also further reducing the risk of voice coil lead wires interfering with diaphragm vibration and affecting speaker sound production.

In this embodiment, the current signal from the external circuit enters the speaker 100 through the external solder pad 2311a, flows through the first voice coil 221 via the first solder pad 2331 of the first lead connecting portion and the first input lead wire 2231, then flows out through the first output lead wire 2233 and the second solder pad 2332, then flows through the second voice coil 222 via the conductive part 2322, the third solder pad 2431, and the second input lead wire 2234, and finally returns to the external circuit through the second output lead wire 2232, the fourth solder pad 2432, and the external solder pad 2311a, completing the circuit.

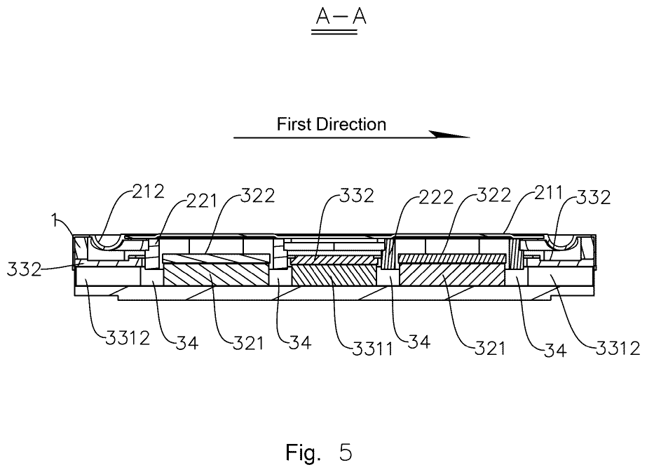

As shown in FIGS. 4-5, the magnetic circuit system 3 includes a lower plate 31, two inner magnetic circuit portions 32 connected to the lower plate 31, and an outer magnetic circuit portion 33 arranged surrounding the two inner magnetic circuit portions 32. The two inner magnetic circuit portions 32 correspond to the voice coil 22 and are respectively surrounded by the first voice coil 221 and the second voice coil 222. The two inner magnetic circuit portions 32 and the outer magnetic circuit portion 33 jointly form a magnetic gap 34, in which the voice coil 22 is inserted. When the voice coil 22 is energized, the generated magnetic field interacts with the magnetic circuit system 3, driving the diaphragm 21 to vibrate and generate sound.

Preferably, as shown in FIG. 2, each of the two inner magnetic circuit portions 32 includes an inner magnet 321 fixed to the lower plate 31 and an inner pole piece 322 covering a side of the inner magnet 321 away from the lower plate, and the outer magnetic circuit portion 33 includes an outer magnet 331 fixed to the lower plate 31 and an outer pole piece 332 covering a side of the outer magnet 331 away from the lower plate. The outer pole piece 332 includes two first axial sides 3321 extending along the first direction and two first protruding parts 3322 extending from the two first axial sides 3321 respectively away from the voice coil 22.

Preferably, the outer magnet 331 includes a first outer magnetic part 3311 arranged between the two inner magnets 321, four second outer magnetic parts 3312 surrounding the inner magnets 321, wherein each second outer magnetic part 3312 includes a first side 3312a extending along the first direction and a second side 3312b extending along the second direction, and the outer magnet 331 further includes a third outer magnetic part 3313 arranged between adjacent two first sides 3312a. This arrangement of the second outer magnetic parts 3312 and the third outer magnetic part 3313 can effectively improve the risk of breakage of the slender outer magnet when the speaker accidentally drops and the uncontrollable position of breakage. In this embodiment, the shape of the second outer magnet is set to be similar to an L-shape, which can further improve the anti-breakage strength of the magnet while effectively concentrating the magnetic field in the magnetic gap at this position, improving the BL value.

Preferably, as shown in FIG. 4, the length d1 of the first side 3312a in the second direction is smaller than the length d2 of the third outer magnetic part 3313 in the second direction. This arrangement can maximize the utilization of the speaker's internal space while increasing the volume of magnets in the magnetic circuit system, improving the BL value, thereby making the speaker's sound performance more superior.

Preferably, as shown in FIG. 4, the length d3 of the first outer magnetic part 3311 in the second direction is smaller than the length d4 of the inner magnet 321 in the second direction. This arrangement can balance the magnetic field strength at various magnetic gaps to improve the acoustic stability of the speaker. Meanwhile, it can effectively avoid interference or obstruction of the magnetic circuit system to the first lead connecting portion.

Compared with related technology, the speaker of the present application, by arranging multiple voice coils, can significantly improve the structural strength of the diaphragm and greatly increase the frequency of high-frequency resonance modes. Meanwhile, by positioning the first lead connecting portion near the middle position between the first voice coil and the second voice coil, where the diaphragm deformation is minimal, it can effectively reduce the relative displacement between the first lead connecting portion and the voice coil, reducing the possibility of fatigue breakage.

The foregoing is merely illustrative of embodiments of the present invention, and it should be noted that modifications may be made to those skilled in the art without departing from the spirit of the invention but are intended to be within the scope of the inventio.

What is claimed is:

1. A speaker, comprising a frame, a vibration system fixed to the frame, and a magnetic circuit system driving the vibration system to vibrate;
the vibration system including a diaphragm fixed to the frame, a voice coil driving the diaphragm to vibrate and generate sound, and a first flexible support connecting the voice coil and an external circuit;
the voice coil including a first voice coil and a second voice coil that are arranged side by side along a first direction and fixed to a side of the diaphragm close to the magnetic circuit system; wherein
the first flexible support is arranged on one side of the voice coil along a second direction perpendicular to the first direction and includes a first main body portion fixed to the frame, a first extension portion extending and bending from the first main body portion toward the diaphragm and fixed to the diaphragm, and a first lead connecting portion extending from the first extension portion toward a middle position between the first voice coil and the second voice coil; the first direction and the second direction are both perpendicular to a vibration direction of the diaphragm, and lead wires of the voice coil are electrically connected to the first lead connecting portion.

2. The speaker as described in claim 1, wherein the first main body portion is provided with an external solder pad connected to the external circuit, the lead wires include a first input lead wire and a second output lead wire, and the first lead connecting portion includes a first solder pad electrically connected to the first input lead wire and a second solder pad electrically connected to the output lead wire.

3. The speaker as described in claim 1, wherein the first main body portion includes two elastic arms spaced apart along the first direction, and the first extension portion includes two supporting parts extending and bending from the two elastic arms respectively toward the diaphragm and fixed to the diaphragm, and a conductive part connecting the two supporting parts.

4. The speaker as described in claim 1, wherein the speaker further includes a second flexible support arranged on another side of the voice coil along the second direction, the second flexible support includes a second main body portion fixed to the frame, a second extension portion extending and bending from the second main body portion toward the diaphragm and fixed to the diaphragm, and a second lead connecting portion extending from the second extension portion toward the middle position between the first voice coil and the second voice coil; the lead wires include a first output lead wire and a second input lead wire, and the second lead connecting portion includes a third solder pad electrically connected to the first output lead wire and a fourth solder pad electrically connected to the second input lead wire.

5. The speaker as described in claim 1, wherein the magnetic circuit system includes a lower plate, two inner magnetic circuit portions connected to the lower plate, and an outer magnetic circuit portion arranged surrounding the two inner magnetic circuit portions; the two inner magnetic circuit portions correspond to the voice coil and are respectively surrounded by the first voice coil and the second voice coil, and the two inner magnetic circuit portions and the outer magnetic circuit portion jointly form a magnetic gap in which the voice coil is inserted.

6. The speaker as described in claim 5, wherein each of the two inner magnetic circuit portions includes an inner magnet fixed to the lower plate and an inner pole piece covering a side of the inner magnet away from the lower plate, and the outer magnetic circuit portion includes an outer magnet fixed to the lower plate and an outer pole piece covering a side of the outer magnet away from the lower plate.

7. The speaker as described in claim 6, wherein the outer pole piece includes two first axial sides extending along the first direction and two first protruding parts extending from the two first axial sides respectively away from the voice coil.

8. The speaker as described in claim 6, wherein the outer magnet includes a first outer magnetic part arranged between the two inner magnets, four second outer magnetic parts surrounding the two inner magnets; each of the four second outer magnetic parts includes a first side extending along the first direction and a second side extending along the second direction, and the outer magnet further includes a third outer magnetic part arranged between adjacent two first sides.

9. The speaker as described in claim 8, wherein a length d1 of the first side in the second direction is smaller than a length d2 of the third outer magnetic part in the second direction.

10. The speaker as described in claim 8, wherein a length d3 of the first outer magnetic part in the second direction is smaller than a length d4 of the inner magnet in the second direction.
